(19) United States
(12) Patent Application Publication
(10) Pub. No.: US 2026/0037183 A1
(43) Pub. Date: Feb. 5, 2026

(54) MEMORY CONTROLLERS, MEMORY SYSTEMS AND CONTROL METHODS THEREOF, MEMORY MEDIUMS, AND PROGRAM PRODUCTS

(71) Applicant: YANGTZE MEMORY TECHNOLOGIES CO., LTD., Wuhan (CN)

(72) Inventors: Tao XIONG, Wuhan (CN); Lijian DENG, Wuhan (CN)

(21) Appl. No.: 19/012,248

(22) Filed: Jan. 7, 2025

(30) Foreign Application Priority Data
Jul. 30, 2024 (CN) 202411034710.6

(51) Int. Cl. G06F 3/06

(52) U.S. Cl. CPC G06F 3/0659; G06F 3/0611; G06F 3/0679

(57) ABSTRACT

The present disclosure provides memory systems, memory controllers, control methods, computer readable memory mediums, and computer program products. An example method includes: in response to an operation instruction, determining whether a first condition is met; in response to the first condition being met, sending a first command sequence corresponding to the operation instruction to a memory device; and in response to the first condition not being met, sending a second command sequence corresponding to the operation instruction to the memory device.

### CROSS-REFERENCE TO RELATED APPLICATIONS

The present application claims the benefit of priority to China Application No. 202411034710.6, filed on Jul. 30, 2024, the content of which is incorporated herein by reference in its entirety.

### TECHNICAL FIELD

The present disclosure relates to the field of semiconductor technology, and particularly to memory systems, memory controllers, control methods, computer readable memory mediums, and computer program products.

### BACKGROUND

Currently, with the wide application and technological development of memory devices, requirements for performance of the memory devices become increasingly high. For example, in a memory system, requirements for both high random read performance and random read latency are very high. The high random read performance typically refers to optimal performance that may be achieved when a memory device processes a random read operation, and the random read latency refers to a duration from the sending of a read request to the start of data transmission required when the memory device processes a random read operation.

### SUMMARY

Examples of the present disclosure provide a memory system, a memory controller, a control method, a computer readable memory medium, and a computer program product.

According to an aspect of the examples of the present disclosure, a memory system is provided, which comprises: a memory device; and a memory controller coupled to the memory device, wherein the memory controller is configured to: in response to an operation instruction, determine whether a first condition is met; in response to the first condition being met, send a first command sequence corresponding to the operation instruction to the memory device; and in response to the first condition not being met, send a second command sequence corresponding to the operation instruction to the memory device.

In one example, the first condition is that a number of commands in a command queue is greater than a first command number threshold.

In one example, the first condition is that a sum of execution durations of commands in a command queue is greater than a first duration threshold.

In one example, the operation instruction comprises a read operation instruction, the second command sequence comprises a read state command, and the first command sequence does not comprise the read state command.

In one example, the first command sequence comprises a page read access command, a change read column address command, and a data output; and the memory controller is configured to: after sending the page read access command, wait for a first wait duration, and send the change read column address command.

In one example, the first wait duration is longer than a maximum of page read access time (tR) plus read cycle time (tRRC).

In one example, the read state command comprises a first read state command, and the second command sequence comprises a page read access command, the first read state command, a change read column address command, and a data output; the first read state command is a cache state read command; the page read access command and the first read state command in the second command sequence are spaced apart by a second wait duration; and the second wait duration is longer than the page read access time (tR).

In one example, the read state command further comprises a second read state command, the second command sequence further comprises the second read state command, the second read state command is a flash array state read command, and the second read state command is after the data output.

In one example, a value range of the first command number threshold is [1, 128/N], and N is a number of back-end processors in the memory controller.

According to another aspect of the present disclosure, a memory system is provided, which comprises: a memory device; and a memory controller coupled to the memory device, wherein the memory controller is configured to: in response to a read operation instruction, determine whether a first condition is met; and in response to the first condition being met, send a first command sequence corresponding to the read operation instruction to the memory device, wherein the first command sequence comprises a page read access command, a change read column address command, and a data output.

In one example, the first condition is that a number of commands in a command queue is greater than a first command number threshold.

In one example, the first condition is that a sum of execution durations of commands in a command queue is greater than a first duration threshold.

In one example, the memory controller is configured to: after sending the page read access command, wait for a first wait duration, and send the change read column address command.

In one example, the first wait duration is longer than a maximum of page read access time (tR) plus read cycle time (tRRC).

In one example, a value range of the first command number threshold is [1, 128/N], and N is a number of back-end processors in the memory controller.

In one example, the memory controller is configured to: in response to the first condition not being met, send a second command sequence corresponding to the read operation instruction to the memory device, wherein the second command sequence comprises a read state command.

In one example, the read state command comprises a first read state command, and the second command sequence comprises the page read access command, the first read state command, the change read column address command, and the data output; the first read state command is a cache state read command; the page read access command and the first read state command in the second command sequence are spaced apart by a second wait duration; and the second wait duration is longer than the page read access time (tR).

In one example, the read state command further comprises a second read state command, the second command sequence further comprises the second read state command, the second read state command is a flash array state read command, and the second read state command is after the data output.

According to another aspect of the present disclosure, a memory controller is provided, which comprises: a controller memory configured to store a control instruction; and a flash controller coupled to the controller memory and configured to execute the control instruction to perform processing comprising: in response to an operation instruction, determining whether a first condition is met; in response to the first condition being met, sending a first command sequence corresponding to the operation instruction to a memory device; and in response to the first condition not being met, sending a second command sequence corresponding to the operation instruction to the memory device.

In one example, the first condition is that a number of commands in a command queue is greater than a first command number threshold.

In one example, the first condition is that a sum of execution durations of commands in a command queue is greater than a first duration threshold.

In one example, the operation instruction comprises a read operation instruction; the second command sequence comprises a read state command, and the first command sequence does not comprise the read state command.

In one example, the first command sequence comprises a page read access command, a change read column address command, and a data output; and the flash controller is configured to: after sending the page read access command, wait for a first wait duration, and send the change read column address command.

In one example, the first wait duration is longer than a maximum of page read access time (tR) plus read cycle time (tRRC).

In one example, the read state command comprises a first read state command, and the second command sequence comprises the page read access command, the first read state command, the change read column address command, and the data output; the first read state command is a cache state read command; the page read access command and the first read state command in the second command sequence are spaced apart by a second wait duration; and the second wait duration is longer than the page read access time (tR).

In one example, the read state command further comprises a second read state command, the second command sequence further comprises the second read state command, the second read state command is a flash array state read command, and the second read state command is after the data output.

In one example, a value range of the first command number threshold is [1, 128/N], and N is a number of back-end processors in the memory controller.

According to still another aspect of the present disclosure, a memory controller is provided, which comprises: a controller memory configured to store a control instruction; and a flash controller coupled to the controller memory and configured to execute the control instruction to perform processing comprising: in response to a read operation instruction, determining whether a first condition is met; and in response to the first condition being met, sending a first command sequence corresponding to the read operation instruction to a memory device, wherein the first command sequence comprises a page read access command, a change read column address command, and a data output.

In one example, the first condition is that a number of commands in a command queue is greater than a first command number threshold.

In one example, the first condition is that a sum of execution durations of commands in a command queue is greater than a first duration threshold.

In one example, the flash controller is configured to: after sending the page read access command, wait for a first wait duration, and send the change read column address command.

In one example, the first wait duration is longer than a maximum of page read access time (tR) plus read cycle time (tRRC).

In one example, a value range of the first command number threshold is [1, 128/N], and N is a number of back-end processors in the memory controller.

In one example, the flash controller is configured to: in response to the first condition not being met, send a second command sequence corresponding to the read operation instruction to the memory device, wherein the second command sequence comprises a read state command.

In one example, the read state command comprises a first read state command, and the second command sequence comprises the page read access command, the first read state command, the change read column address command, and the data output; the first read state command is a cache state read command; the page read access command and the first read state command in the second command sequence are spaced apart by a second wait duration; and the second wait duration is longer than the page read access time (tR).

In one example, the read state command further comprises a second read state command, the second command sequence further comprises the second read state command, the second read state command is a flash array state read command, and the second read state command is after the data output.

According to yet still another aspect of the present disclosure, a control method of a memory system is provided, wherein the method comprises: in response to an operation instruction, determining whether a first condition is met; in response to the first condition being met, sending a first command sequence corresponding to the operation instruction to a memory device; and in response to the first condition not being met, sending a second command sequence corresponding to the operation instruction to the memory device.

In one example, the first condition is that a number of commands in a command queue is greater than a first command number threshold; or the first condition is that a sum of execution durations of commands in a command queue is greater than a first duration threshold.

In one example, the operation instruction comprises a read operation instruction; the second command sequence comprises a read state command, and the first command sequence does not comprise the read state command.

In one example, the first command sequence comprises a page read access command, a change read column address command, and a data output; and the method comprises: after sending the page read access command, waiting for a first wait duration, and sending the change read column address command.

In one example, the first wait duration is longer than a maximum of page read access time (tR) plus read cycle time (tRRC).

In one example, the read state command comprises a first read state command, the second command sequence comprises a page read access command, the first read state command, a change read column address command, and a data output sequentially, and the first read state command is a cache state read command; the page read access command and the first read state command in the second command sequence are spaced apart by a second wait duration; and the second wait duration is longer than the page read access time (tR).

In one example, the read state command further comprises a second read state command, the second command sequence further comprises the second read state command, the second read state command is a flash array state read command, and the second read state command is after the data output.

In one example, a value range of the first command number threshold is [1, 128/N], and N is a number of back-end processors in the memory controller.

According to yet still another aspect of the present disclosure, a control method of a memory system is provided, which comprises: in response to a read operation instruction, determining whether a first condition is met; and in response to the first condition being met, sending a first command sequence corresponding to the read operation instruction to a memory device, wherein the first command sequence comprises a page read access command, a change read column address command, and a data output.

In one example, the first condition is that a number of commands in a command queue is greater than a first command number threshold.

In one example, the first condition is that a sum of execution durations of commands in a command queue is greater than a first duration threshold.

In one example, the method comprises: after sending the page read access command, waiting for a first wait duration, and sending the change read column address command.

In one example, the first wait duration is longer than a maximum of page read access time (tR) plus read cycle time (tRRC).

In one example, a value range of the first command number threshold is [1, 128/N], and N is a number of back-end processors in the memory controller.

In one example, the memory controller is configured to: in response to the first condition not being met, send a second command sequence corresponding to the read operation instruction to the memory device, wherein the second command sequence comprises a read state command.

In one example, the read state command comprises a first read state command, the second command sequence comprises the page read access command, the first read state command, the change read column address command, and the data output sequentially, and the first read state command is a cache state read command; the page read access command and the first read state command in the second command sequence are spaced apart by a second wait duration; and the second wait duration is longer than the page read access time (tR).

In one example, the read state command further comprises a second read state command, the second command sequence further comprises the second read state command, the second read state command is a flash array state read command, and the second read state command is after the data output.

According to yet still another aspect of the present disclosure, a computer readable memory medium is provided, wherein a control instruction in the computer readable memory medium, when executed by a controller processor, enables the controller processor to perform the control method described above.

According to yet still another aspect of the present disclosure, a computer program product is provided, which comprises a computer program/instruction, wherein the computer program/instruction, when executed by a processor, enables the control method described above to be implemented.

The above general description and the following detailed description are merely exemplary and explanatory, and cannot limit the present disclosure.

### BRIEF DESCRIPTION OF THE DRAWINGS

The accompanying drawings herein are incorporated into the specification to constitute a part of the specification, illustrate examples conforming to the present disclosure, and are used to explain the principle of the present disclosure together with the specification. Apparently, the drawings described below are only some examples of the present disclosure simply. A person of ordinary skill in the art may obtain other drawings according to such drawings without creative work.

FIG. 1A illustrates a schematic diagram of a system having a memory system in examples of the present disclosure.

FIG. 1B illustrates a schematic diagram of a memory card having a memory system in examples of the present disclosure.

FIG. 1C illustrates a schematic diagram of a solid state drive having a memory system in examples of the present disclosure.

FIG. 1D illustrates a schematic diagram of a system having a memory system in examples of the present disclosure.

FIG. 1E illustrates a schematic diagram of a memory device comprising a memory cell array and a peripheral circuit in examples of the present disclosure.

FIG. 1F illustrates a schematic diagram of a memory device architecture having a memory system in examples of the present disclosure.

FIG. 2 illustrates a flow diagram of a control method of a memory system in an example of the present disclosure.

FIG. 3 illustrates a flow diagram of a control method of a memory system in another example of the present disclosure.

FIG. 4 illustrates a flow diagram of a control method of a memory system in still another example of the present disclosure.

FIG. 5 illustrates a flow diagram of a control method of a memory system in yet still another example of the present disclosure.

FIG. 6 illustrates a flow diagram of a control method of a memory system in yet still another example of the present disclosure.

FIG. 7 illustrates a flow diagram of a control method of a memory system in yet still another example of the present disclosure.

FIG. 8 illustrates a flow diagram of calculating execution durations of all commands in a command queue in an example of the present disclosure.

FIG. 9 illustrates a schematic diagram of a cache read and a direct page read in an example of the present disclosure.

FIG. 10 illustrates a schematic diagram of a command sequence in an example of the present disclosure.

FIG. 11 illustrates an example timing diagram of the command sequence in FIG. 10.

FIG. 12 illustrates a schematic diagram of a command sequence in another example of the present disclosure.

FIG. 13 illustrates an example timing diagram of the command sequence in FIG. 12.

FIG. 14 illustrates a schematic structural diagram of a flash controller in an example of the present disclosure.

### DETAILED DESCRIPTION

Examples are described more comprehensively with reference to the drawings. However, the examples can be implemented in various forms and should not be construed as being limited to examples set forth herein. In contrast, these examples are provided for a thorough and complete understanding of the present disclosure, and to fully convey the concept of the examples to a person skilled in the art. Same reference numerals in the drawings denote same or like parts, and thus repeated descriptions thereof are omitted.

The features, structures or characteristics described in the present disclosure may be combined in one or more implementations in any proper manner. In the following description, many specific details are provided thereby giving a full understanding of the implementations of the present disclosure. However, those skilled in the art will realize that the technical solutions of the present disclosure may be practiced and one or more of the particular details may be omitted, or other methods, elements, apparatuses, operations, etc., may be employed. In other cases, well-known methods, apparatuses, implementations, or operations are not shown or described in detail to avoid obscuring aspects of the present disclosure.

The accompanying drawings are schematic illustrations, in which same reference numerals denote same or like parts, and thus repeated descriptions thereof are omitted. Some block diagrams shown in the drawings do not necessarily correspond to physically or logically separate entities. These functional entities may be implemented in a software form, or implemented in at least one hardware module or integrated circuit, or implemented in different networks and/or processor apparatuses and/or microcontroller apparatuses.

The flow diagrams in the accompanying drawings are merely example illustrations that do not necessarily comprise all the contents and operations, nor are they necessarily executed in a described order. For example, some operations may be divided, and some operations may be combined or partially combined, so that an actual order of execution may change depending on actual situations.

In the specification, the terms “one”, “a”, “the”, “the described” and “at least one” are used to indicate the presence of at least one element/constituent part/etc.; the terms “comprise”, “include” and “have” are used to indicate open inclusion and mean that there may be other elements/components/etc., in addition to those listed elements/components/etc.; and the terms “first”, “second” and “third”, etc. are used only as labels instead of limitations to the amounts of objects.

In a NAND flash, tR and tRRC are two time-relevant parameters relating to a timing of read operations. They are explained as follows.

Read Access Time (tR) refers to a time interval from the sending of a read command to a moment when valid data can be read. It represents a minimum latency required by a NAND flash chip for a read operation. In an example, tR refers to a total duration of a series of operations, such as data transmission, decoding, checking, and error correction, inside the chip after the read command arrives at the NAND chip. Generally, shorter tR means a faster read operation speed.

Read Cycle Time (tRRC) refers to a minimum time interval between two consecutive read operations. It represents an additional latency between successive read operations required by the NAND flash chip. After a read operation, the chip requires a duration to recover to a stable state before a next read operation. tRRC comprises the additional wait duration. Shorter tRRC means that the chip can perform successive read operations faster. These timing parameters are relevant to reading data correctly and ensuring the system performance. System designers need to select appropriate timing parameters according to a specification table and an application requirement of the NAND chip, so as to ensure the correctness of the read operation and to meet a performance requirement. It is to be noted that, NAND flash chips from different vendors may have different timing parameters and specifications, and specific values may vary. Therefore, reference may be made to a specification table of a specific chip to acquire accurate and latest information.

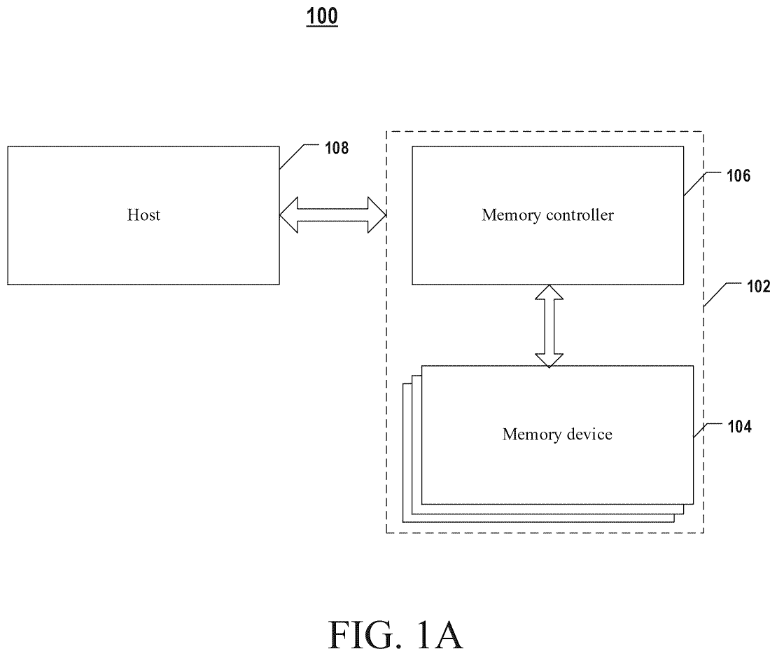

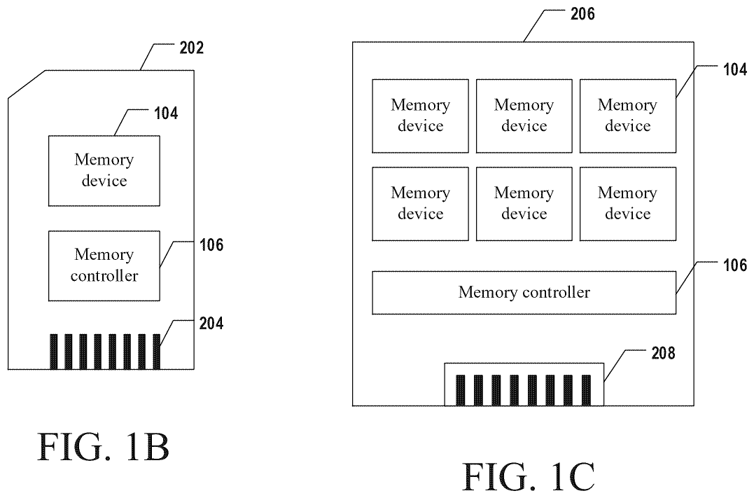

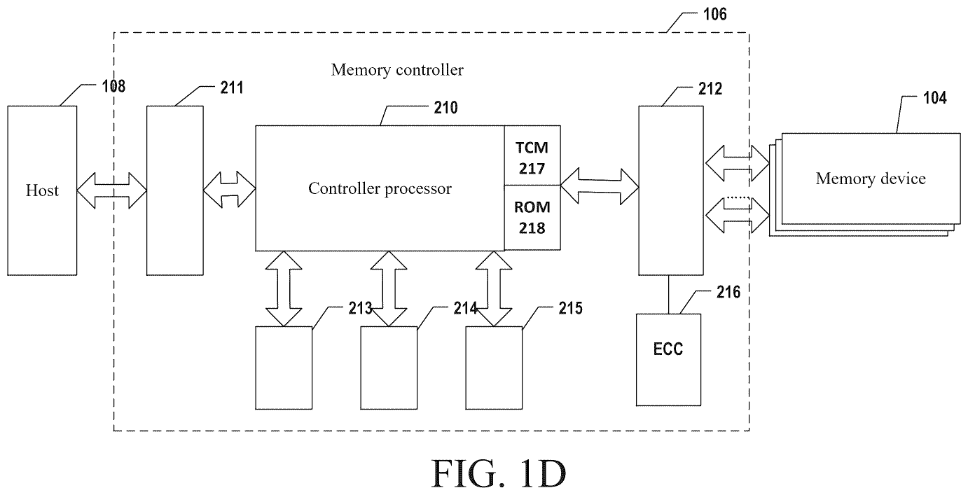

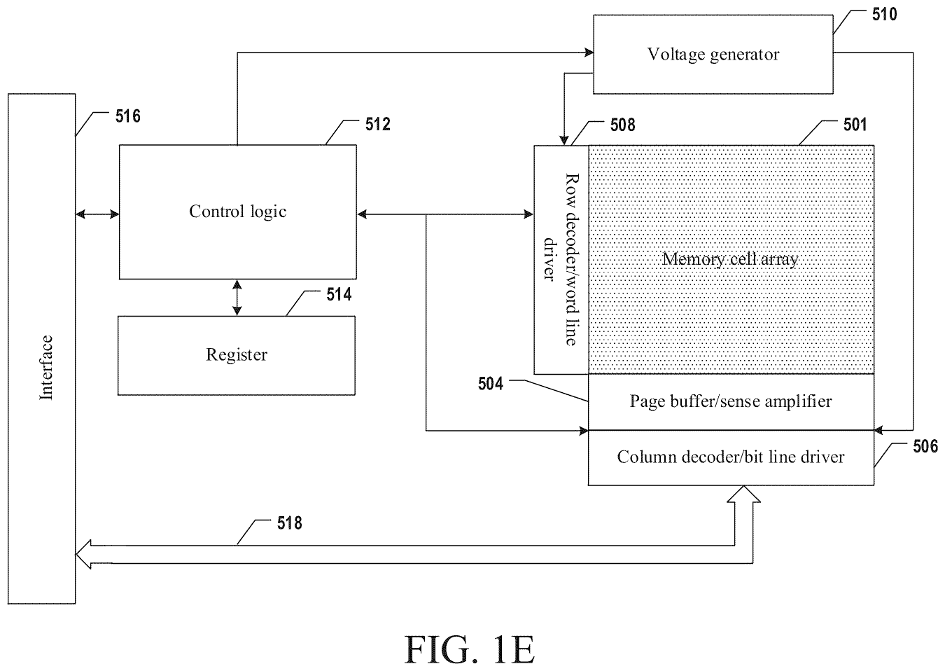

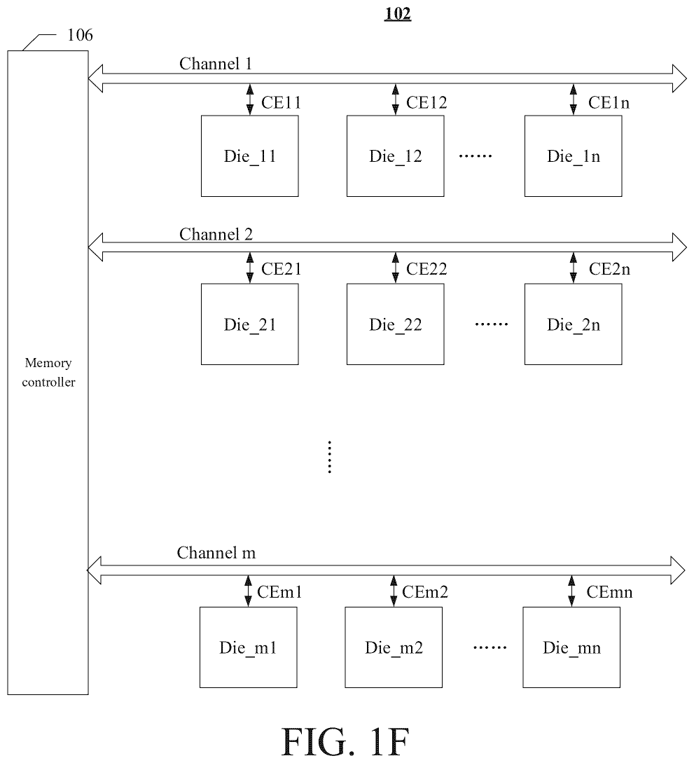

FIG. 1A illustrates a schematic diagram of a system having a memory system in examples of the present disclosure. As shown in FIG. 1, the system 100 may be a mobile phone, a desktop computer, a laptop computer, a tablet computer, a vehicle computer, a game console, a printer, a positioning device, a wearable electronic device, a smart sensor, a Virtual Reality (VR) device, an Augmented Reality (AR) device or any other suitable electronic devices having memory devices therein. As shown in FIG. 1A, the system 100 may comprise a host 108 and a memory system 102. The memory system 102 has one or more memory devices 104 and a memory controller 106.

The host 108 may be a processor (e.g., a Central Processing Unit (CPU)) or a System on a Chip (SoC) (e.g., an Application Processor (AP)) of an electronic device. The host 108 may be coupled to the memory controller 106, and is configured to send or receive data to or from the memory device 104 through the memory controller 106. For example, the host 108 may send program data in a program operation or receive read data in a read operation. The host 108 is configured to receive and send instructions and commands from and to the memory controller 106 of the memory system 102, and perform or implement a plurality of functions and operations provided in the present disclosure, which will be described below.

The memory device 104 may be any memory device disclosed in the present disclosure, e.g., a NAND flash memory device, which comprises a page buffer having a plurality of portions. It is to be noted that for illustrative purposes, a NAND flash is merely an example of the memory device. The memory device 104 may include any suitable non-volatile memory, such as a NOR flash, a Ferroelectric Random Access Memory (FeRAM), a Phase Change Memory (PCM), a Magnetic Random Access Memory (MRAM), a Spin-Transfer Torque Random Access Memory (STT-RAM), or a Resistive Random Access Memory (RRAM). In some implementations, the memory device 104 comprises a three-dimensional (3D) NAND flash memory.

The memory controller 106 may be implemented through any of the following: a microprocessor, a microcontroller (also referred to as a Microcontroller Unit (MCU)), a Digital Signal Processor (DSP), an Application Specific Integrated Circuit (ASIC), a Field-Programmable Gate Array (FPGA), a Programmable Logic Device (PLD), a state machine, a gating logic, a discrete hardware circuit, and other suitable hardware, firmware, or software configured to perform various functions described below in detail.

According to some implementations, the memory controller 106 is coupled to the memory device 104 and the host 108, and configured to control the memory device 104. The memory controller 106 can manage data stored in the memory device 104 and communicate with the host 108. In some implementations, the memory controller 106 is designed for operating in a low duty-cycle environment, such as a Secure Digital (SD) card, a Compact Flash (CF) card, a Universal Serial Bus (USB) flash drive, or other media for use in electronic devices (such as a personal computer, a digital camera, and a mobile phone). In some implementations, the memory controller 106 is designed for operating in a high duty-cycle environment, such as an SSD or an embedded MultiMedia Card (eMMC) that is used as a data memory apparatus for a mobile device (such as a smartphone, a tablet computer, and a laptop computer) and an enterprise memory array. The memory controller 106 may be configured to control operations of the memory device 104, such as read, erase, and program operations, by providing instructions such as a read instruction to the memory device 104. For example, the memory controller 106 may be configured to provide the read instruction to a peripheral circuit of the memory device 104 to control the read operation. The memory controller 106 may be further configured to manage various functions with respect to data stored or to be stored in the memory device 104, including, but not limited to, bad block management, Garbage Collection (GC), logical-to-physical address conversion, and wear leveling, etc. In some implementations, the memory controller 106 is further configured to process an Error Correcting Code (ECC) with respect to data read from or written to the memory device 104. The memory controller 106 may also perform any other suitable functions, e.g., formatting the memory device 104.

The memory controller 106 may communicate with an external device (e.g., the host 108) according to a particular communication protocol. For example, the memory controller 106 may communicate with the external device through at least one of various interface protocols, such as a USB protocol, a Multi Media Card (MMC) protocol, a Peripheral Component Interconnect (PCI) protocol, a Peripheral Component Interconnect Express (PCI-Express, PCI-E) protocol, an Advanced Technology Attachment (ATA) protocol, a serial ATA protocol, a parallel ATA protocol, a Small Computer System Interface (SCSI) protocol, an Enhanced Small Drive Interface (ESDI) protocol, an Integrated Drive Electronics (IDE) protocol, and a Firewire protocol.

The memory controller 106 and one or more memory devices 104 may be integrated into various types of memory devices, e.g., be included in the same package (such as a Universal Flash Storage (UFS) package or an eMMC package). For example, the memory system 102 may be implemented and packaged into different types of end electronic products.

In one example as shown in FIG. 1B, the memory controller 106 and the memory device 104 may be integrated into a memory card 202. The memory card 202 may include a PC (Personal Computer Memory Card International Association (PCMCIA)) card, a CF card, a Smart Media (SM) card, a memory stick, a Multi Media Card (MMC), an SD card, and a UFS, etc. The memory card 202 may further comprise a memory card connector 204 coupling the memory card with a host (e.g., the host 108 in FIG. 1).

In another example as shown in FIG. 1C, the memory controller 106 and a plurality of memory devices 104 may be integrated into a solid state drive 206. The solid state drive 206 may further comprise a solid state drive connector 208 coupling the solid state drive 206 with a host (e.g., the host 108 in FIG. 1). In some implementations, the memory capacity and/or operation speed of the solid state drive 206 are greater than the memory capacity and/or operation speed of the memory card 202.

FIG. 1D illustrates a schematic diagram of an example memory controller having a memory system in examples of the present disclosure. As shown in FIG. 1D, the memory controller 106 is connected with the host 108 and one or more memory devices 104 respectively by coupling, and is configured to control sending of data from the host 108 to the memory device 104 or reading of data from the memory device 104 and returning of the data to the host 108. The memory controller 106 at least comprises: a controller processor 210, a host interface controller 211, a flash controller 212, a controller memory 213, a hardware accelerator 214, a buffer memory 215, an ECC 216, a Tightly Coupled Memory (TCM) 217, and a ROM (e.g., an instruction or command cache) 218.

The controller processor 210, a part of the memory controller 106, is configured to execute a control logic and an algorithm of the memory controller, and is responsible for processing functions such as command queuing, address mapping, garbage collection, data compression, and input/output control. The controller processor 210 may be implemented through an embedded processor or FPGA.

The host interface controller 211, coupled with the host 108 and the controller processor 210 respectively, is a communication interface component between the host and the memory controller, and is responsible for data transmission between the host and the memory controller, comprising read and write of data and receiving and sending of a command. The host interface controller typically supports various interfaces (e.g., Serial Advanced Technology Attachment (SATA), and PCIe) and protocols (e.g., Advanced Host Controller Interface (AHCI), and Non-Volatile Memory Express (NVMe)), and provides a data transmission function.

The flash controller 212, coupled with the memory device 104 and the controller processor 210 respectively, is a communication interface component between the memory device and the memory controller, and is responsible for implementing functions such as reading and writing of data, erasing, and address mapping.

The controller memory 213, coupled with the controller processor 210, is a memory region for storing instructions and data of the controller, and may provide quick read and write operations and a real-time control function. The controller memory usually employs a memory medium such as a NOR flash, a NAND flash, or a RAM.

The hardware accelerator 214 is coupled with the controller processor 210, and is a component for optimizing some particular operations. The hardware accelerator optimizes the performance of some particular operations by using a hardware logical circuit, so as to improve the performance and data security of the memory device. For example, the hardware accelerator may be configured to process tasks, such as encryption, decryption, compression, decompression, and error correction codec. In addition, the hardware accelerator may be also configured to improve operations, such as data searching and sorting.

The buffer memory 215, coupled with the controller processor 210, is a component configured to store data temporarily, and may be also configured to buffer instructions and data. The buffer memory typically employs a high-speed memory device, such as a Dynamic Random-Access Memory (DRAM) and a Static Random-Access Memory (SRAM), so as to improve the read write performance of the memory controller and reduce a latency.

The ECC 216 is configured to detect and correct an error in data read from the memory device. ECC check data is stored in a reserved space of the memory device 104 for data check.

The technical solutions of the present disclosure are used to optimize a NAND bus command sequence that may be used in firmware development of an SSD. A code implementation may be integrated into a firmware code of the SSD, stored in a non-volatile memory (e.g., the memory device 104), run in the TCM 217 or command cache ROM 218 of the memory controller (e.g., an SOC chip on the SSD).

The memory controller 106 is configured to receive and send a command from and to the host 108, and perform or implement a plurality of functions and operations provided in the present disclosure, which will be described below.

FIG. 1E illustrates a schematic diagram of an example memory device comprising a memory cell array and a peripheral circuit in examples of the present disclosure. As shown in FIG. 1E, the memory device may comprise a memory cell array 501 and a peripheral circuit coupled to the memory cell array 501. The peripheral circuit may comprise: a page buffer/sense amplifier 504, a column decoder/bit line driver 506, a row decoder/word line driver 508, a voltage generator 510, a control logic 512, a register 514, an interface 516, and a data bus 518. It is to be understood that in some examples, additional peripheral circuits not shown in FIG. 1E may be included as well.

The page buffer/sense amplifier 504 may be configured to read and program (write) data from and to the memory cell array 501 according to control signals from the control logic 512. In one example, the page buffer/sense amplifier 504 may store one page of program data (write data) to be programmed into the memory cell array 501. In another example, the page buffer/sense amplifier 504 may perform a program verify operation to ensure that data has been properly programmed into memory cells of a selected word line. In still another example, the page buffer/sense amplifier 504 may also sense a low power signal from a bit line that represents a data bit stored in the memory cell, and amplify a small voltage swing to a recognizable logic level in a read operation.

The column decoder/bit line driver 506 may be configured to be controlled by the control logic 512 and select one or more NAND memory strings by applying a bit line voltage generated from the voltage generator 510. Data input from the data bus 518 is directed (routed) to a desired region (e.g., a group) of memory cells of the memory cell array 501, and data output from the desired region of memory cells is directed (routed) to the data bus 518.

The row decoder/word line driver 508 may be configured to be controlled by the control logic 512 and a selected block and a word line of the selected block of the memory cell array 501. The row decoder/word line driver 508 may be further configured to drive the selected word line using a word line voltage generated from the voltage generator 510. The voltage generator 510 may be configured to be controlled by the control logic 512, and generate the word line voltage (such as a read voltage, a program voltage, a pass voltage, a local voltage, and/or a verify voltage) to be supplied to the memory cell array 501.

The control logic 512 may be coupled to each of the above peripheral circuits and configured to control operations of each peripheral circuit. The register 514 may be coupled to the control logic 512 and comprise a state register, a command register, and an address register configured to store state information, a command operation code, and a command address for controlling the operations of each peripheral circuit. The interface 516 may be coupled to the control logic 512, and act as a control buffer to buffer and relay a control command received from the host to the control logic 512 and buffer and relay state information received from the control logic 512 to the host. The interface 516 may be also coupled to the column decoder/bit line driver 506 through the data bus 518, and act as a data interface and a data buffer to buffer and relay write data received from a host (not shown) to the memory cell array 501 or buffer and relay data from the memory cell array 501.

FIG. 1F illustrates a schematic diagram of an example memory device architecture having a memory system in examples of the present disclosure. As shown in FIG. 1F, the memory system 102 is provided with the one or more memory devices 104 and the memory controller 106.

The memory controller 106 is connected with the one or more memory devices 104 by coupling through a plurality of physical channels, so as to send a control command or transmit data to the memory device 104. The memory device 104 comprises one or more dies. Each physical channel is connected with one or more dies. Each die corresponds to a respective Chip Enable (CE) signal.

The control command sent by the memory controller 106 to the memory device 104 comprises the chip enable signal, where a corresponding die in the physical channel is gated through the chip enable signal, for example, a target die of the control command is selected.

In some memory operations, one operation instruction usually corresponds to only one command sequence, in which case different performance requirements cannot be met. To mitigate such a situation, the present disclosure provides support for providing different command sequences for the same operation instruction in different situations. As such, different requirements for performance in different situations may be met.

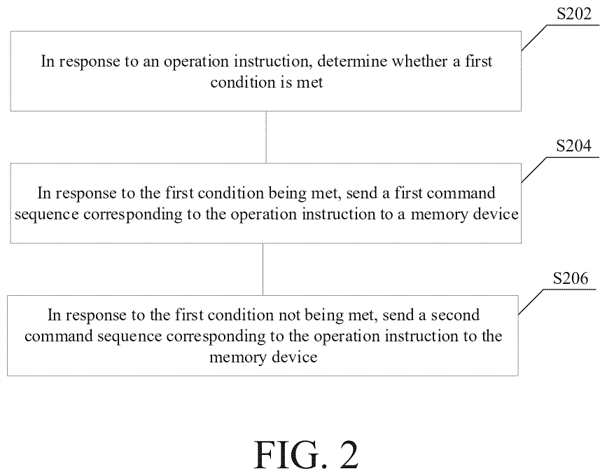

Examples of the technical solutions of the present disclosure are explained and described below in conjunction with FIGS. 2 to 14 and may be applicable to systems or devices as shown in FIGS. 1A-1F.

FIG. 2 illustrates a flow diagram of a control method of a memory system in an example of the present disclosure.

As shown in FIG. 2, in operation S202, in response to an operation instruction, determining whether a first condition is met is performed. In one example, the operation instruction comprises a read command. When receiving the operation instruction, the memory controller judges whether the first condition is met. In one example, the operation instruction comprises a write command. In one example, the first condition is that a number of commands in a command queue is greater than a first command number threshold. In one example, the first condition is that a sum of execution durations of commands in a command queue is greater than a first duration threshold.

In operation S204, in response to the first condition being met, a first command sequence corresponding to the operation instruction is sent to a memory device. When determining that the first condition is met, the memory controller sends the first command sequence corresponding to the operation instruction to the memory device. In one example, the operation instruction comprises a read operation instruction, and the first command sequence corresponds to the operation instruction and does not comprise a read state command.

In operation S206, in response to the first condition not being met, a second command sequence corresponding to the operation instruction is sent to the memory device. When determining that the first condition is not met, the memory controller sends the second command sequence corresponding to the operation instruction to the memory device. In one example, the operation instruction comprises a read operation instruction, and the first command sequence comprises a read state command.

In the above example, when receiving the operation instruction, the memory controller first judges whether the first condition is met, and sends the first command sequence corresponding to the operation instruction to the memory device when the condition is met, otherwise sends the second command sequence corresponding to the operation instruction to the memory device. As such, different high requirements for performance under different conditions may be met, thereby improving the system efficiency.

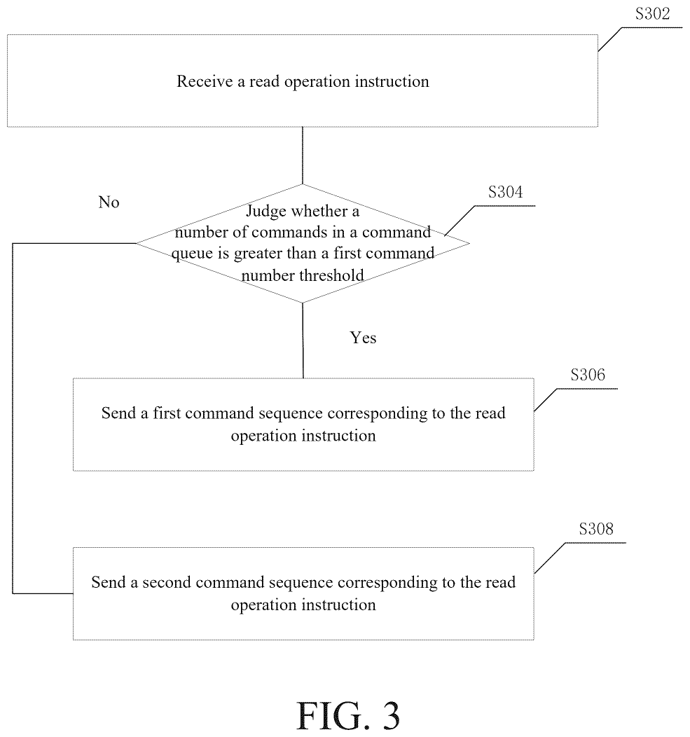

FIG. 3 illustrates a flow diagram of a control method of a memory system in another example of the present disclosure. In this example, the first condition is that a number of commands in a command queue is greater than a first command number threshold.

As shown in FIG. 3, in operation 302, the memory controller receives a read operation instruction.

In operation S304, the memory controller judges whether the number of commands in a command queue is greater than the first command number threshold. If yes, operation S306 is performed next, otherwise, operation S308 is performed next. In one example, a value range of the first command number threshold is [1, 128/N], and N is a number of back-end processors in the memory controller. In one example, the value of the first command number threshold is 7, 8, or 9.

In operation 306, the memory controller sends a first command sequence corresponding to the read operation instruction to the memory device. In one example, the first command sequence does not comprise a read state command.

In operation 308, the memory controller sends a second command sequence corresponding to the read operation instruction to the memory device. In one example, the first command sequence comprises the read state command.

In the above example, when receiving the read operation instruction, the memory controller judges whether the number of commands in the command queue is greater than the first command number threshold; when the number of commands in the command queue is greater than the first command number threshold, sends the first command sequence corresponding to the read operation instruction to the memory device, e.g., the first command sequence that does not comprise the read state command, so as to reduce a random read latency; and when the number of commands in the command queue is less than or equal to the first command number threshold, sends the second command sequence, e.g., the second command sequence comprising the read state command, so as to improve the highest random read performance. As such, different high requirements for performance in different situations may be met.

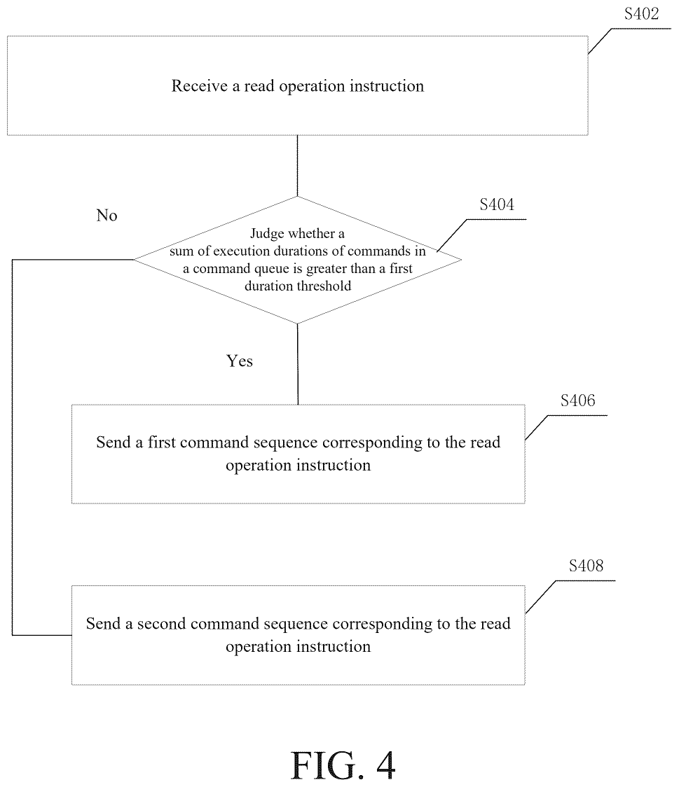

FIG. 4 illustrates a flow diagram of a control method of a memory system in still another example of the present disclosure. In this example, the first condition is that a sum of execution durations of commands in a command queue is greater than a first duration threshold.

As shown in FIG. 4, in operation 402, the memory controller receives a read operation instruction.

In operation 404, the memory controller judges whether the sum of execution durations of commands in a command queue is greater than the first duration threshold. If yes, operation S406 is performed next, otherwise, operation S408 is performed next.

In operation 406, the memory controller sends a first command sequence corresponding to the read operation instruction to the memory device. In one example, the first command sequence does not comprise a read state command.

In operation 408, the memory controller sends a second command sequence corresponding to the read operation instruction to the memory device. In one example, the second command sequence comprises the read state command.

In the above example, when receiving the read operation instruction, the memory controller judges whether the sum of execution durations of commands in a command queue is greater than the first duration threshold; when the sum of execution durations of commands in a command queue is greater than the first duration threshold, sends the first command sequence corresponding to the read operation instruction to the memory device, e.g., the first command sequence that does not comprise the read state command, so as to reduce a random read latency; and when the sum of execution durations of commands in a command queue is less than or equal to the first duration threshold, sends the second command sequence, e.g., the second command sequence comprising the read state command, so as to improve the highest random read performance. As such, different high requirements for performance in different situations may be met. Through the sum of execution durations of commands, a judgement for the resource utilization situation of the system may be more accurate.

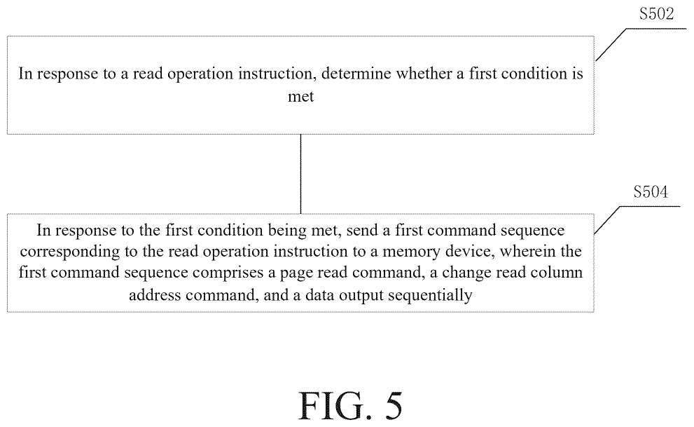

FIG. 5 illustrates a flow diagram of a control method of a memory system in yet still another example of the present disclosure.

As shown in FIG. 5, in S502, in response to a read operation instruction, determining whether a first condition is met is performed. In one example, the first condition is that a number of commands in a command queue is greater than a first command number threshold. In one example, the first condition is that a sum of execution durations of commands in a command queue is greater than a first duration threshold.

S504: In response to the first condition being met, a first command sequence corresponding to the read operation instruction is sent to the memory device, where the first command sequence comprises a page read access command, a change read column address command, and a data output.

In the above example, the memory controller receives the read operation instruction, and when determining that the first condition is met, sends the first command sequence corresponding to the read operation instruction to the memory device, where the first command sequence comprises the page read access command, the change read column address command, and the data output. As such, the random read latency is reduced, and the system performance is improved.

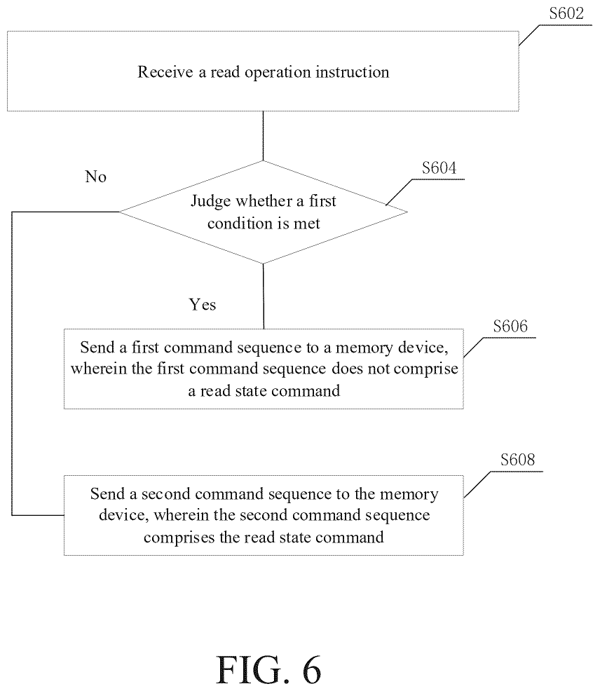

FIG. 6 illustrates a flow diagram of a control method of a memory system in yet still another example of the present disclosure.

As shown in FIG. 6, in operation S602, a read operation instruction is received.

In operation S604, judging whether a first condition is met is performed; if yes, operation S606 is performed next, otherwise, operation S608 is performed next.

In operation S606, a first command sequence is sent to the memory device, where the first command sequence does not comprise a read state command.

In operation S608, a second command sequence is sent to the memory device, where the second command sequence comprises the read state command.

In the above example, when the read operation instruction is received, if the first condition is met, the first command sequence that does not comprise the read state command is sent to the memory device, so as to reduce the random read latency; and if the first condition is not met, the second command sequence comprising the read state command is sent to the memory device, so as to improve the highest random read performance, thereby improving the system performance.

In one example, the first command sequence comprises a page read access command, a change read column address command, and a data output; and the method comprises: after sending the page read access command, waiting for a first wait duration, and sending the change read column address command. In one example, the first wait duration is longer than a maximum of page read access time (tR) plus read cycle time (tRRC).

In one example, the second command sequence comprises the read state command, the read state command comprises a first read state command, and the second command sequence comprises a page read access command, the first read state command, a change read column address command, and a data output; the first read state command is a cache state read command; the page read access command and the first read state command in the second command sequence are spaced apart by a second wait duration; and the second wait duration is longer than the page read access time (tR). In one example, the read state command further comprises a second read state command, the second command sequence further comprises the second read state command, the second read state command is a flash array state read command, and the second read state command is after the data output.

Table 1 below is an illustration of some terms involved in the technical solutions of the present disclosure.

TABLE 1

| Terms | Description |
|---|---|
| NAND Array Ready | It means that a NAND array is not in a busy state and may |
| | receive and process a command |
| NAND Cache Ready | It means that a NAND cache is not in a busy state (but the |
| | NAND array may be in the busy state), and may transmit data, |
| | but is not necessarily able to receive and process a command |
| tCCS | It refers to a change column setup duration, which is a duration |
| | required for a wait after sending of 06h-e0h during a data read |
| | and is about 300 ns |
| tRRC | It refers to a duration from a NAND cache ready state to a |
| | NAND array read state and is about 4 us |
| tR w/o tRRC | It refers to a duration of reading data from NAND, which does |
| | not comprise tRRC |
| tR w/ tRRC | It refers to a duration of reading data from NAND, which |
| | comprises tRRC |

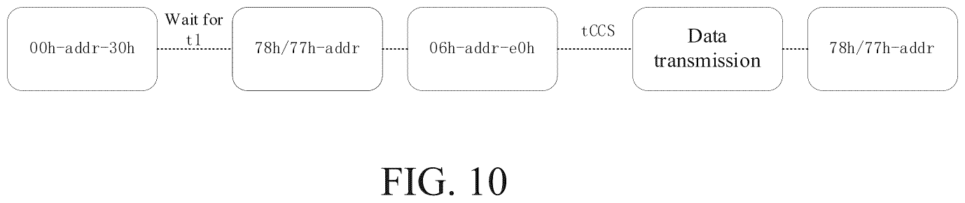

Specific examples of the first command sequence and the second command sequence are described below in conjunction with FIGS. 10 to 13.

FIG. 10 illustrates a schematic diagram of a command sequence in an example of the present disclosure. The command sequence is an example of the second command sequence.

As shown in FIG. 10, the command sequence comprises the following:
sending a command 00h-addr-30h or 00-addr-20h;
waiting for a fixed duration t1, where t1 is slightly greater than tR w/o tRRC; and different pages (LP, MP, and UP) may correspond to different wait durations t1;
sending a cache state read command, command 78h/77h-addr, and detecting a NAND state until the NAND cache ready state is detected, with a detection interval of t2.
sending a command 06h-addr-e0h;
waiting for a duration tCCS;
performing data transmission; and
sending a NAND array state read command, command 78h/77h-addr, and detecting a NAND state until the NAND array ready state is detected, with a detection interval of t2.

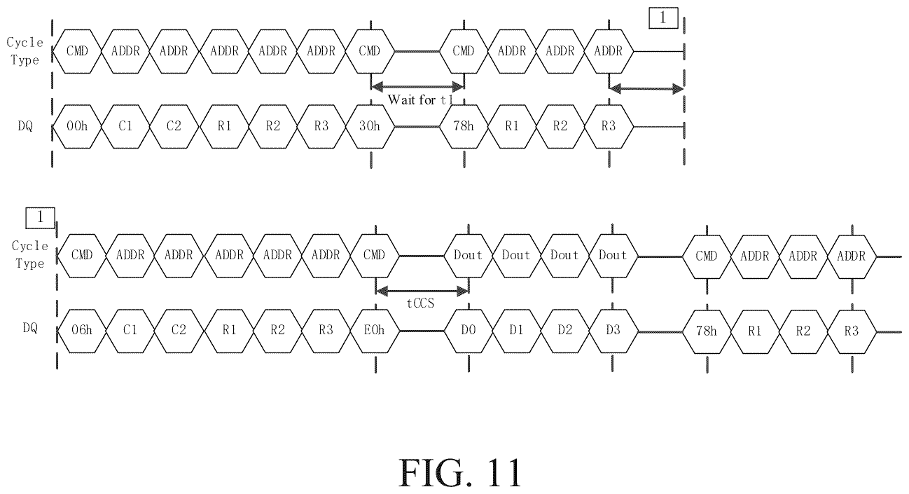

FIG. 11 illustrates an example timing diagram of the command sequence in FIG. 10. Addresses C1 and C2 represent column addresses of a page to be read, and addresses R1-R3 represent row addresses of the page to be read. D0-D3 represent output data.

In the above example, different NAND command sequences are sent according to different random read loads. The above command sequence (second command sequence) is sent in case of a low load, so as to reduce a latency of the random read command as much as possible.

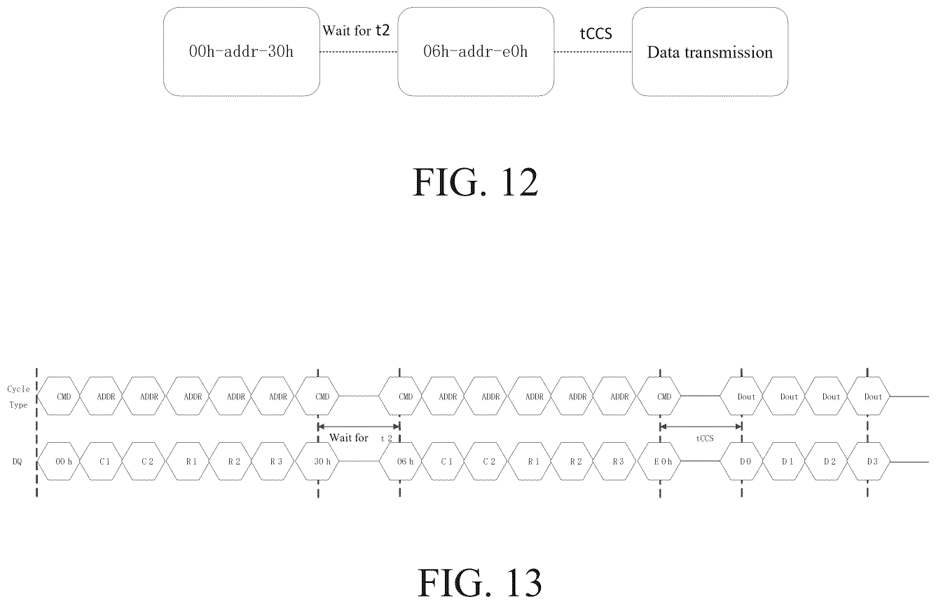

FIG. 12 illustrates a schematic diagram of a command sequence in another example of the present disclosure. The command sequence is an example of the first command sequence.

As shown in FIG. 12, the command sequence comprises the following:
sending 00h-addr-30h or 00-addr-20h;
waiting for a fixed duration t1, where t1 is greater than a maximum value of tR w/tRRC plus a margin; and different pages (LP, MP, and UP) may correspond to different wait durations;
sending a command 06h-addr-e0h;
waiting for a duration tCCS; and
performing data transmission.

FIG. 13 illustrates an example timing diagram of the command sequence in FIG. 12. Addresses C1 and C2 represent column addresses of a page to be read, and addresses R1-R3 represent row addresses of the page to be read. D0-D3 represent output data.

In the above example, different NAND command sequences are sent according to different random read loads. The above command sequence (first command sequence) is sent in case of a high load, so as to increase the efficiency of a NAND bus during a random read as much as possible.

In one example, the memory controller performs the judgment of the first condition and the sending of the command sequence, where the judgment of the first condition corresponds to the judgment of a working mode as follows, and the sending of the command sequence corresponds to the sending of a NAND bus command as follows.

### 1) Judgment of a Working Mode

A flash controller (e.g., a back-end CPU of a Solid State Drive (SSD) controller) of the memory controller performs a judgment for a low-load read mode or a high-load read mode according to a number of random read commands being processed currently from the host. If a number of commands being processed currently in the command queue is less than a certain threshold (such as 8), the judgment indicates a low-load mode, otherwise a high-load mode.

### 2) Sending of a NAND Bus Command

The flash controller (e.g., the back-end CPU of the SSD controller) decides to send the first command sequence or the second command sequence to the NAND bus according to the current load mode. The first command sequence is sent in case of the low-load read mode, otherwise the second command sequence is sent.

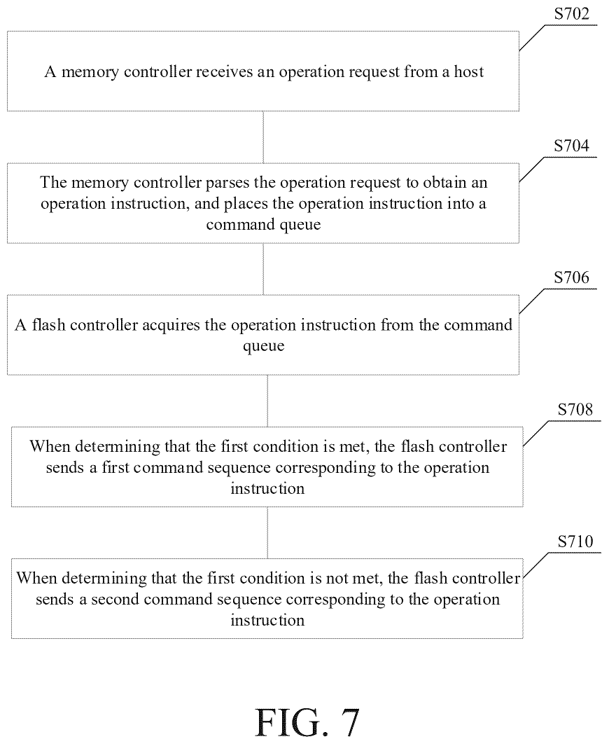

FIG. 7 illustrates a flow diagram of a control method of a memory system in yet still another example of the present disclosure.

As shown in FIG. 7, in operation S702, the memory controller receives an operation request from the host.

In operation S704, the memory controller parses the operation request to obtain an operation instruction, places the operation instruction into a command queue, searches for a corresponding physical address according to a logical address in the operation instruction, and replaces the logical address in the operation instruction with the found physical address.

In operation S706, the flash controller acquires the operation instruction from the command queue. For example, the operation instruction is a read operation instruction or a write operation instruction.

In operation S708, when determining that the first condition is met, the flash controller sends a first command sequence corresponding to the operation instruction to the memory device. In one example, the first condition is that a number of commands in the command queue is greater than the first command number threshold. In one example, the first condition is that a sum of execution durations of commands in the command queue is greater than the first duration threshold.

In operation S710, when determining that the first condition is not met, the flash controller sends a second command sequence corresponding to the operation instruction to the memory device.

In the above example, after receiving the operation request from the host, the memory controller parses the operation request to obtain the operation instruction, and places the operation instruction into the command queue; the flash controller converts the operation instruction into different command sequences according to different situations and sends them to the memory device, so as to improve different performances in different situations, thereby improving the overall performance of the system.

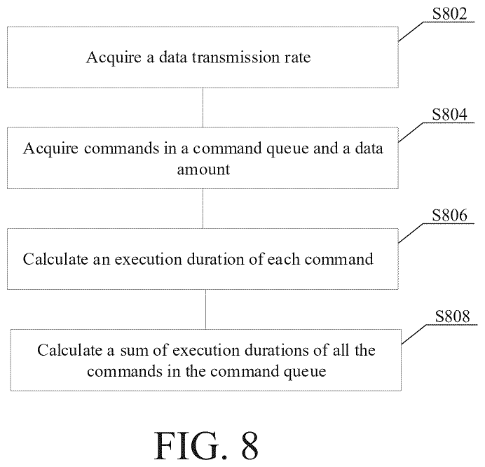

FIG. 8 illustrates a flow diagram of calculating execution durations of all commands in a command queue in an example of the present disclosure. In this example, how to calculate execution durations of all commands in a command queue is introduced.

As shown in FIG. 8, in operation S802, a data transmission rate is acquired.

In operation S804, the commands in the command queue and corresponding data amount are acquired.

In operation S806, an execution duration of each command is calculated.

In operation S808, the sum of the execution durations of all the commands in the command queue is calculated.

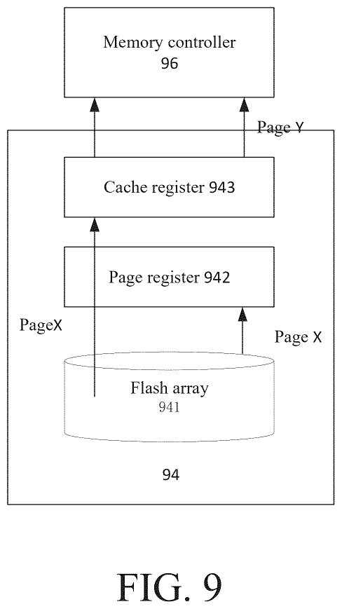

FIG. 9 illustrates a schematic diagram of a cache read and a direct page read in an example of the present disclosure. As shown in FIG. 9, the memory system comprises a memory device 94 and a memory controller 96. The memory device 94 comprises a flash array 941, a page register 942, and a cache register 943. When the memory controller 96 reads data from the memory device 94, in one manner, data in the flash array 941 is directly read into the cache register 943 and then the data in the cache register 943 is transmitted to the memory controller 96; in another manner, data in the flash array 941 is first read into the page register 942, then the data in the page register 942 is sent to the cache register 943, and the memory controller 96 reads the data from the cache register 943. As such, the reading of data from the cache register 943 by the memory controller 96 and the reading of data from the flash array 941 by the page register 942 may be processed in parallel, improving the read efficiency. The first read manner corresponds to the second command sequence, in which the second command sequence is sent in case of a low load, so as to reduce the latency of the random read command. The second read manner corresponds to the first command sequence, in which the first command sequence is sent in case of a high load, so as to take full advantage of the fact that data can be transmitted in the cache ready state of the NAND, thereby improving the highest random read performance.

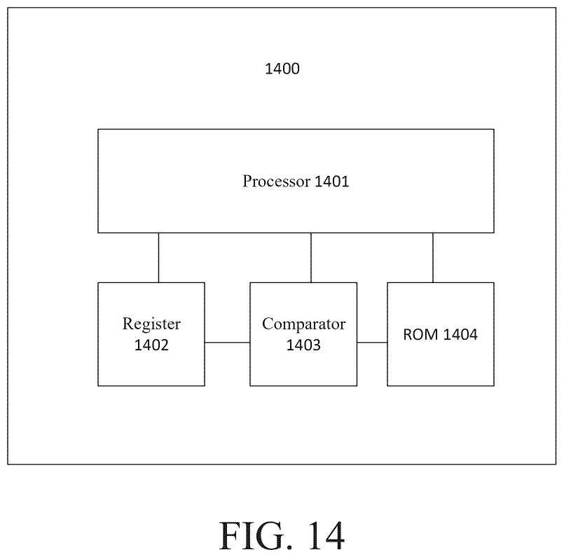

FIG. 14 illustrates a schematic structural diagram of the flash controller in an example of the present disclosure. As shown in FIG. 14, the flash controller 1400 comprises a processor 1401, a register 1402, a comparator 1403, and a ROM 1404, where the register 1402 is configured to store a number of commands in a command queue, and the ROM 1404 is configured to store the first command sequence and the second command sequence. The flash controller 1400 acquires the operation instruction, and stores, in the register 1402, the acquired number of commands in the command queue. The comparator 1403 compares the number of commands that is stored in the register 1402 with the first command number threshold. If the number of commands is greater than the first command number threshold, the first command sequence stored in the ROM 1404 is sent to the memory device, otherwise, the second command sequence stored in the ROM 1404 is sent to the memory device.

In the technical solutions of the present disclosure, different NAND command sequences are employed in different scenarios, so as to ensure high performance of a sequential read and also ensure a low latency of a random read in case of a low queue depth (QD).

In the examples, a computer readable memory medium comprising an instruction is also provided, e.g., the controller memory comprising an instruction, where the instruction is executable by the controller processor of the memory controller to implement the above method. In an example, the computer readable memory medium may be a ROM, a random access memory (RAM), a CD-ROM, a magnetic tape, a floppy disk, and an optical data memory device, etc.

In the examples, a computer program product comprising a computer program/instruction is also provided, where the computer program/instruction, when executed by a processor, implements the method in the above examples.

It is to be understood that, reference to “some examples” throughout the specification means that particular features, structures, or characteristics related to the examples are included in at least one example of the present disclosure. Thus, the appearances of the phrase “in some examples” or “in some other examples” everywhere throughout this specification are not necessarily referring to the same example. In addition, these particular features, structures or characteristics may be combined in one or more examples in any proper manner. It is to be understood that, in various examples of the present disclosure, sequence numbers of the above processes do not indicate an execution sequence, and an execution sequence of various processes shall be determined by functionalities and intrinsic logics thereof, and shall constitute no limitation on an implementation process of the examples of the present disclosure. The above sequence numbers of the examples of the present disclosure are used for description only, and do not represent goodness and badness of the examples.

It is to be noted that, the terms “include”, “comprise”, or any variants thereof herein are intended to cover non-exclusive inclusion, such that a process, a method, an article, or an apparatus comprising a series of elements comprise not only those elements, but also other elements not listed explicitly, or elements inherent to this process, method, article, or apparatus. An element defined by a statement “comprising one” do not preclude the presence of another identical element in the process, method, article or apparatus comprising this element, without more limitations.

In several examples provided by the present disclosure, it is to be understood that the disclosed device and method may be implemented in other manners. The device examples described above are illustrative only, for example, the division of units is merely a logical functional division. In a practical implementation, there may be another manner for division. For example, a plurality of units or components may be combined, or may be integrated into another system, or some features may be ignored or not performed. In addition, the coupling or direct coupling or communicative connection between various constituent parts as shown or as discussed may be implemented through indirect coupling or communicative connection of some interfaces, devices or units, and may be electrical, mechanical or in other forms.

The above-mentioned units described as separate components may or may not be physically separated. The components shown as units may or may not be physical units. They may be located in one place, or may be distributed onto a plurality of network units. According to actual needs, part or all of the units may be selected for realizing the purposes of the solution of the example.

In addition, various functional units in each example of the present disclosure may be all integrated into one processing unit, or each unit may serve as one unit individually, or two or more units may be integrated into one unit. The above-mentioned integrated unit may be implemented in a hardware form or in a form of hardware and software functional units.

The above descriptions are merely example implementations of the present disclosure, and the protection scope of the present disclosure is not limited thereto. Any variations or replacements readily conceivable by a person familiar with the existing technology within the technical scope disclosed by the present disclosure shall fall within the protection scope of the present disclosure. Therefore, the protection scope of the present disclosure shall be defined by the protection scope of the claims.

What is claimed is:

1. A memory system, comprising:
a memory device; and
a memory controller coupled to the memory device, wherein the memory controller is configured to:
in response to receiving an operation instruction, determine whether a first condition is met;
in response to the first condition being met, send a first command sequence corresponding to the operation instruction to the memory device, the first command sequence lacking a read state command; and
in response to the first condition not being met, send a second command sequence corresponding to the operation instruction to the memory device, the second command sequence comprising the read state command.

2. The memory system of claim 1, wherein the first condition comprises a number of commands in a command queue being greater than a first command number threshold;
or
the first condition comprises a sum of execution durations of commands in a command queue being greater than a first duration threshold.

3. The memory system of claim 1, wherein the first command sequence comprises a page read access command, a change read column address command, and a data output; and
the memory controller is configured to:
after sending the page read access command, wait for a first wait duration, and send the change read column address command.

4. The memory system of claim 3, wherein the first wait duration is longer than a maximum of page read access time (tR) plus read cycle time (tRRC).

5. The memory system of claim 1, wherein the read state command comprises a first read state command, and the second command sequence comprises a page read access command, the first read state command, a change read column address command, and a data output;
the first read state command is a cache state read command; the page read access command and the first read state command in the second command sequence are spaced apart by a second wait duration; and the second wait duration is longer than a page read access time.

6. The memory system of claim 5, wherein the read state command further comprises a second read state command, the second command sequence further comprises the second read state command, the second read state command is a flash array state read command, and the second read state command is after the data output.

7. The memory system of claim 2, wherein a value range of the first command number threshold is [1, 128/N], and N is a number of back-end processors in the memory controller.

8. A memory controller, comprising:
a controller memory configured to store a control instruction; and
a flash controller coupled to the controller memory and configured to execute the control instruction to perform processing comprising:
in response to receiving an operation instruction, determining whether a first condition is met;
in response to the first condition being met, sending a first command sequence corresponding to the operation instruction to a memory device, the first command sequence lacking a read state command; and
in response to the first condition not being met, sending a second command sequence corresponding to the operation instruction to the memory device, the second command sequence comprising the read state command.

9. The memory controller of claim 8, wherein the first condition is that a number of commands in a command queue is greater than a first command number threshold;
or
the first condition is that a sum of execution durations of commands in a command queue is greater than a first duration threshold.

10. The memory controller of claim 9, wherein the first command sequence comprises a page read access command, a change read column address command, and a data output; and
the flash controller is configured to:
after sending the page read access command, wait for a first wait duration, and send the change read column address command.

11. The memory controller of claim 10, wherein the first wait duration is longer than a maximum of page read access time (tR) plus read cycle time (tRRC).

12. The memory controller of claim 9, wherein the read state command comprises a first read state command, and the second command sequence comprises a page read access command, the first read state command, a change read column address command, and a data output;
the first read state command is a cache state read command; the page read access command and the first read state command in the second command sequence are spaced apart by a second wait duration; and the second wait duration is longer than a page read access time.

13. The memory controller of claim 12, wherein the read state command further comprises a second read state command, the second command sequence further comprises the second read state command, the second read state command is a flash array state read command, and the second read state command is after the data output.

14. The memory controller of claim 9, wherein a value range of a first command number threshold is [1, 128/N], and N is a number of back-end processors in the memory controller.

15. A method of controlling a memory system, comprising:
in response to receiving an operation instruction, determining whether a first condition is met;
in response to the first condition being met, sending a first command sequence corresponding to the operation instruction to a memory device, the first command sequence lacking a read state command; and
in response to the first condition not being met, sending a second command sequence corresponding to the operation instruction to the memory device, the second command sequence comprising the read state command.

16. The method of claim 15, wherein the first condition is that a number of commands in a command queue is greater than a first command number threshold;
or
the first condition is that a sum of execution durations of commands in a command queue is greater than a first duration threshold.

17. The method of claim 16, wherein the first command sequence comprises a page read access command, a change read column address command, and a data output; and
the method comprises: after sending the page read access command, waiting for a first wait duration, and sending the change read column address command.

18. The method of claim 17, wherein the first wait duration is longer than a maximum of page read access time (tR) plus read cycle time (tRRC).

19. The method of claim 15, wherein the read state command comprises a first read state command, the second command sequence comprises a page read access command, the first read state command, a change read column address command, and a data output sequentially, and the first read state command is a cache state read command; the page read access command and the first read state command in the second command sequence are spaced apart by a second wait duration; and the second wait duration is longer than a page read access time.

20. The method of claim 19, wherein the read state command further comprises a second read state command, the second command sequence further comprises the second read state command, the second read state command is a flash array state read command, and the second read state command is after the data output.
